(19) United States
(12) Patent Application Publication
(10) Pub. No.: US 2017/0169342 A1
(43) Pub. Date: Jun. 15, 2017

(54) SYSTEM AND METHOD FOR DIAGNOSING AT LEAST ONE COMPONENT REQUIRING MAINTENANCE IN AN APPLIANCE AND/OR INSTALLATION

(71) Applicant: Siemens Aktiengesellschaft, München (DE)

(72) Inventor: Ulli Waltinger, Neuburg (DE)

(21) Appl. No.: 15/358,808

(22) Filed: Nov. 22, 2016

(30) Foreign Application Priority Data
Dec. 14, 2015 (DE) 102015225144.6

(51) Int. Cl. G06N 5/04; G06N 99/00

(52) U.S. Cl. CPC G06N 5/04; G06N 99/005

(57) ABSTRACT

A system for diagnosing at least one component requiring maintenance in an appliance and/or installation, having a) a device, designed for data and/or message interchange with regard to states of one or more components with an analysis unit, b) a device, designed to receive historic data from the one or more components with regard to their life in collective form, c) a device, designed for data and/or message interchange with a learning machine unit that is designed to deliver a predictive model for identifying at least one component requiring maintenance to the device, d) an evaluation device that is designed to use the data and/or messages coming from the analysis unit, e) a device, designed for data and/or message interchange with a monitoring device that is designed to take the one or more identified components requiring maintenance, which can prompt a visual and/or audible display is provided.

### CROSS-REFERENCE TO RELATED APPLICATIONS

This application claims priority to German application No. DE 102015225144.6 having a filing date of Dec. 14, 2015, the entire contents of which are hereby incorporated by reference.

### FIELD OF TECHNOLOGY

The following relates to a system and a method for diagnosing at least one component requiring maintenance in an appliance and/or installation.

### BACKGROUND

Embodiments of the invention concern the field of medical engineering. Other applications are also conceivable, however.

Systems and products operated in medical engineering, such as a C-arm X-ray machine, computed tomography (CT) or magnetic resonance tomography (MRT) machines, for example, consist of a broad quantitative complex of components or appliance parts that are replaceable by spare parts. The replacement of worn or defective appliance parts has a monetary influence on customers and manufacturers, since this replacement requires different service actions, of greater or lesser complexity and cost, in order to guarantee an optimum system response for the customer. Since a manufacturer normally provides several types of service agreement with different ranges of services, which are linked to the products, operational services and service actions, such as the repair and replacement of individual appliance parts at the customer end, are becoming ever more significant in terms of cost and temporal efficiency. Specifically, there are what are known as flat-rate and fixed-rate agreements, which are intended to guarantee the customer a high level of calculability for service costs. When customers call a service center because a particular product is not working, the service center needs to coordinate the service tasks, that is to say initially assimilate the status of and problem with the product, to perform a fault analysis and send out a service engineer to the customer at a given time. Normally, the service work begins by performing an analysis at the log data from the system that is not working. The log data need to be sorted and grouped as appropriate and divided into different fault appliance classes.

Aside from physical faults, for example the failure or rupture of complete parts of the system, analysis and diagnosis on the basis of available log data require context-specific expert knowledge. If the process of log data analysis takes longer and is not finished by the time the service engineer arrives, this results in the service work being able to be completed only rarely. The consequence is that the service engineer needs to travel to the customer a second or possibly a third time.

Tools are possible for making a contribution to a guided analysis or diagnosis process:
A predictive maintenance solution, for example a monitoring program including tube monitoring for the CT machine, which concentrates on existing soft sensors or a prescribed code representation that is able to predict the fault status of a machine or of a subsystem. A disadvantage of such possibly older products can be that existing sensors cannot communicate with the analyzing software. It is desirable for analysis and diagnostic programs to be able to operate with older sensory parts and current sensory parts of a product or of a system.
Reactive maintenance solutions are possible that put the system status into a context with means for analyzing log information, wherein proposed, frequently occurring code anomalies are included in the rating in order to identify the relationships between the system components and are used to identify indicators with a certain probability that relate to affected appliance parts and spare parts.
Rule-based event identification solutions are possible that search system log files and use predefined rules to go through log data streams in order to find indicators for system anomalies.
Systems are possible that contextualize extensive work and are in most cases used at a higher level. They visualize predefined expert events for a prescribed product, with a limited number of replacement actions or fault rectification actions possibly being prescribed. The interpretation and the interaction concerning what service action needs to be performed when and at what time is predominantly left to the service center.

Most of the approaches discussed above are manual or semimanual or automated diagnosis systems whose focus is on individual appliance/spare parts. Certain data features are visualized, with no specific action instructions being proposed.

### SUMMARY

An aspect relates to providing a machine-assisted fault analysis system that makes evaluation and diagnosis of log data faster and reliable.

Embodiments of the invention claim a system for diagnosing at least one component requiring maintenance in an appliance and/or installation, having
a) a device, designed for data and/or message interchange with regard to states of one or more components with an analysis unit that is designed to monitor the states of the one or more components and/or events arising thereon and to output them to the device in a systematized form,
b) a device, designed to receive historic data from one or more components with regard to their life in collective form,
c) a device, designed for data and/or message interchange with a learning machine unit that is designed to deliver a predictive model for identifying at least one component requiring maintenance to the device,
d) an evaluation device that is designed to use the data and/or messages coming from the analysis unit in systematic form, the historic data in collective form and to use the predictive model to identify the one or more components requiring maintenance,
e) a device, designed for data and/or message interchange with a monitoring device that is designed to take the one or more identified components requiring maintenance as a basis for outputting an error message to the monitoring device, which can prompt a visual and/or audible display.

In this case, the display of the error message can be prompted by the monitoring device and forwarded to a further appliance at the customer end.

In other words, there is provision for a learning-based approach to be used in order to put specific faults pertaining to system components into context such that faulty components lead to the most reliable possible spare part predictions or identification. The system according to embodiments of the invention is preferably intended to be installed on the product or at the customer end in order to be able to evaluate malfunctions or faults as appropriate and to link them to appropriate spare parts. To this end, an evaluation device, not shown in the figure, may be provided that can be integrated into the aforementioned monitoring device or the self-diagnosis agent explained in the exemplary embodiment below. The service center can then use such context information to determine the time at which the service engineer travels to the customer.

This allows the service center to work out a more precise schedule for the service engineers. If the method, system and apparatus according to embodiments of the invention allow the service center to access the data that the analysis system according to embodiments of the invention generates for the customer, then said data can be stored in a central database that already stores similar or the same faults from other customers and, possibly, already stores corresponding solution proposals.

One development of embodiments of the invention provides that the learning machine unit is designed to identify, within a determined time window, one or more components requiring maintenance on the basis of a target value, specified by the respective affected component, for a training on the basis of classifications that are derivable from the historic data of the appliance and/or installation.

One development of embodiments of the invention provides that events and/or states are provided in a systematized form according to their frequency, if need be in a manner provided with a weighting that corresponds to their relevance, within a time window.

One development of embodiments of the invention provides that said life represents the average life, the ongoing life cycle and/or the expected life cycle. Said collective form can take the historic data, inter alia, as a basis for reproducing a correlation between the one or more components and other components of the appliance and/or of the installation. Said life can represent an expected life cycle, the average life cycle being related to the ongoing life cycle.

One development of embodiments of the invention provides that the predictive model is representable by a decision tree in which the leaves represent class tags and branches represent relationships to functions and/or rules that lead to these class tags. Relationships can arise or be made by rules or by functions or maps.

One development of embodiments of the invention provides that the evaluation device is integrated in said monitoring device (AD) remotely from the system.

A further aspect of embodiments of the invention is a method for diagnosing at least one component requiring maintenance in an appliance and/or installation, having the following steps:
a) accepting or receiving states from one or more components provided in a systematized form (LR), wherein the states of the one or more components and/or events (E) arising thereon are monitored by an analysis device (LIM),
b) receiving historic data (HD) from the one or more components with regard to their life in collective form (ER),
c) accepting or receiving a predictive model (MM) from a learning machine unit (LMM) that delivers the predictive model (MM) for identifying at least one component requiring maintenance,
d) using the states coming from the analysis unit (LIM) in systematic form (LR), the historic data in collective form (ER) and using the predictive model (MM) to identify the one or more components requiring maintenance,
e) outputting an error message (E) on the basis of the identification of the one or more components requiring maintenance.

The system may be embodied as an apparatus and provide means and/or units or devices and/or modules for performing the aforementioned method that may each be in hardware and/or firmware and/or software form or in the form of a computer program or computer program product.

The method described above, like the system described above, can be developed accordingly.

A further aspect of embodiments of the invention provides an installation having at least one such apparatus.

In this case, the installation comprises at least one component and is characterized by an installation type, inter alia.

### Examples are:

an automation installation,
a manufacturing or production installation,
a cleaning installation,
a water treatment installation,
a machine,
a continuous-flow machine,
a power generating installation,
a power grid,
a power distribution network,
a communication network,
a medical engineering system,
a hospital information system.

A further aspect of embodiments of the invention is a computer program product or a computer program having means for performing the aforementioned method, when the computer program (product) is executed in an aforementioned apparatus or installation.

Embodiments of the invention additionally has the following advantages:
1. The customer can run a self-diagnosis agent or a piece of self-diagnosis software on his product in order to take potential quality assurance measures in order to decide whether or not to contact the service center.
2. Service engineers do not have to work through several thousand lines of system codes in order to identify the currently defective appliance part.
3. Service center personnel can immediately initiate service measures on the basis of the identified affected appliance parts or spare parts.
4. Service engineers can evaluate history data within a database warehouse or other service centers in order to initiate appropriate measures.

### BRIEF DESCRIPTION

Some of the embodiments will be described in detail, with reference to the following figures, wherein like designations denote like members, wherein:

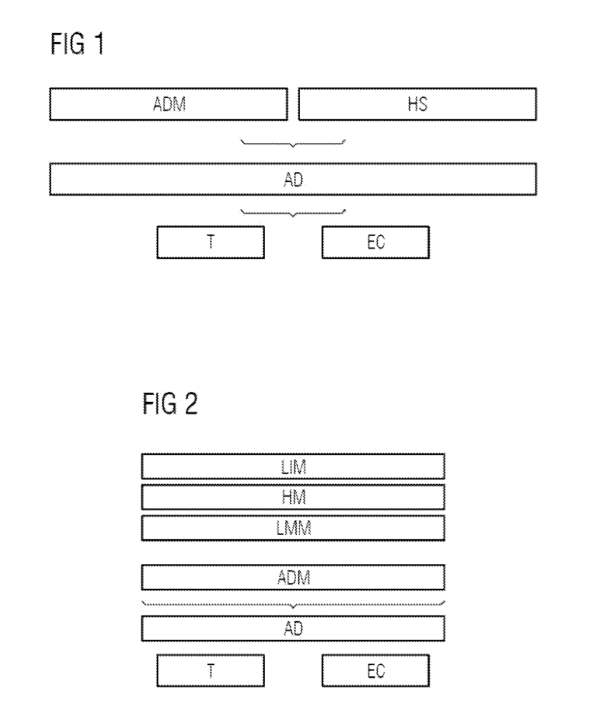

FIG. 1 schematically shows a possible embodiment of a monitoring device e.g. in the form of a self-diagnosis agent that integrates a self-diagnosis manager on the basis of the instance of a medical engineering health system in order to apply a model and to put a prediction into context;

FIG. 2 shows the self-diagnosis agent, which is split and/or divided into individual intercommunicating and reciprocally controllable devices such as a device for controlling an analysis unit e.g. log data integration manager, a device for receiving historic data e.g. from a history data integration manager and a device for controlling a learning machine unit e.g. a learning machine model manager, wherein a system for diagnosing components requiring maintenance e.g. the self-diagnosis agent manager interchanges messages and data with the self-diagnosis agent;

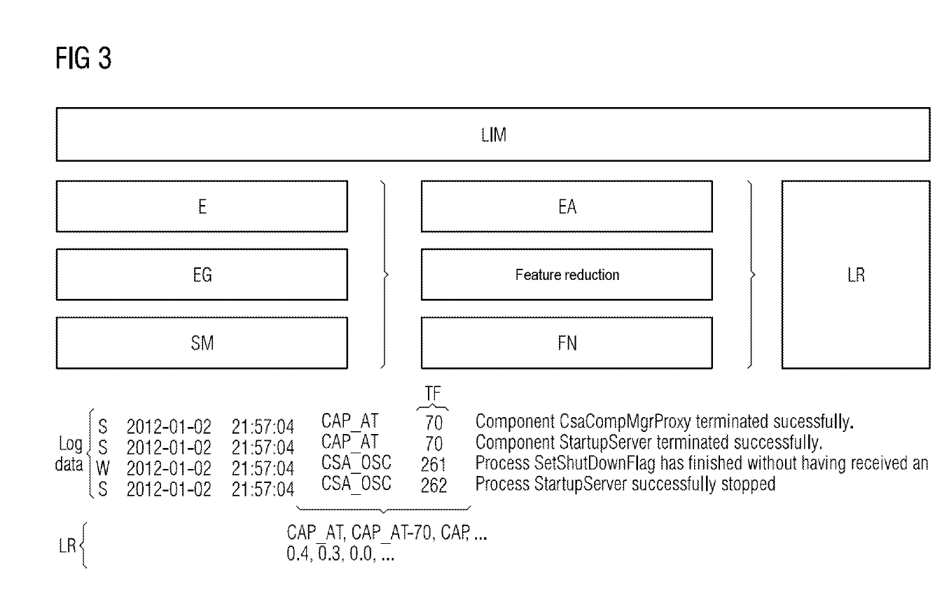

FIG. 3 shows a log data integration manager that converts system log events, group events, and system messages into a numerical matrix representation e.g. log data matrix LR;

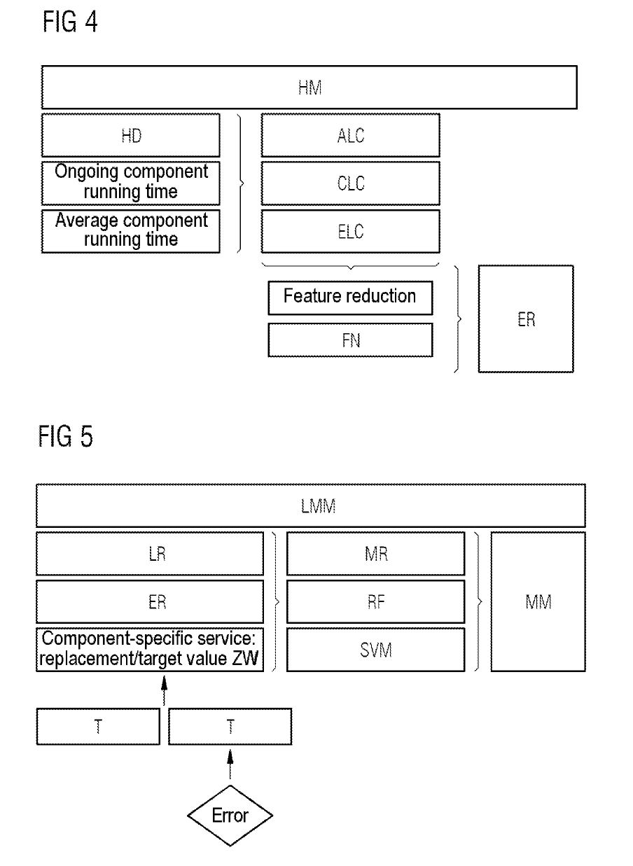

FIG. 4 shows a possible embodiment of a device for receiving historic data, wherein the data are collected by a history data integration manager and provided in a collective form;

FIG. 5 shows the learning machine model manager, which combines the log data and the replacement matrix with replacement service with one another as a target value in order to train a decision model on the basis of historic data; and

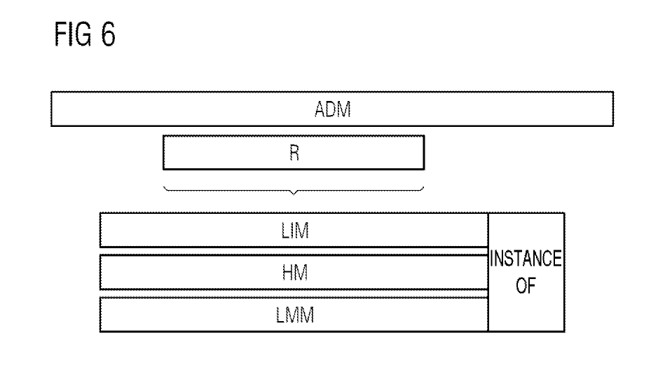

FIG. 6 shows the context in which the self-diagnosis agent the individual managers with their instantiated feature definitions and corresponding trained models.

### DETAILED DESCRIPTION

FIG. 1 schematically shows the context in which embodiments of the invention can be used. This context may relate to a system/appliance to be analyzed for faults in the medical setting or in the installation or manufacturing setting. The components denoted by AD, ADM, LMM, HM and LIM in FIGS. 1 and 2 may be arranged in a single system or distributed over multiple intercommunicating systems locally. As such, the component AD may be installed or implemented e.g. at the customer end and the components ADM may be installed or implemented at the service center end. Similarly, the components LIM, HM and LMM may be integrated in ADM or may be split and/or divided into individual intercommunicating and reciprocally controllable devices. A learning-based, reactive and predictive maintenance and diagnosis solution can identify appliance parts that have faults or are affected by a necessary repair/replacement e.g. T or spare parts of a product, for example a CT or MRT machine, the faults being identified automatically within the complex of appliance parts and spare parts. A transparent decision mechanism for customers and service engineers is supplied by virtue of each spare part being provided, according to the system status, with an optional probability rating.

The customer can activate what is known as a “self-diagnosis agent” AD on his appliance, e.g. a medical engineering system HS, which analyzes the infrastructure of means and system components and appliance parts using log data and predicts a fault type. This agent AD reports that a system component is affected by a fault and a call to the service center is needed. It is also possible for the agent to go through the system on a regular basis and to monitor system states and occurring system events. If a status of the appliance appears erroneous to the agent, it outputs an (error) message EC e.g. “Error Context”. Furthermore, it is possible for multiple customers that have such an automatic diagnosis system or agent to send their log data directly to the service center. The service center then analyzes the customer products and systems on a regular basis and monitors the status thereof. Hence, a potential fault or erroneous status is displayed to the service center in good time before a service engineer is sent to the customer. It is possible for a customer to call a service center and report a fault with a product or a system. The service personnel then logs into the system of the customer remotely and starts the self-diagnosis program or the agent AD thereon. The service personnel then copies the log data onto a computer in the service center and evaluates what spare parts T are needed for the fault. It is also conceivable for the customer, after the self-diagnosis agent is started and running, to transmit the log data to the service center and hence for the service center to be informed about the system status.

The self-diagnosis agent AD can—as shown in FIG. 2—communicate and interchange data and/or messages or reports with the following components. A self-diagnosis agent manager ADM (see FIG. 6) can be used to record instances of the log data integration manager LIM, the history data integration manager HM and the learning machine model manager LMM.

1. A log data integration manager LIM is shown schematically in FIG. 3: the component consists of a formal model that collects system terms through individual events E or grouped event stacks EG. This component converts a prescribed content “Log data” of a log file from an appliance/system into a systematic form or into a combined feature representation in the form of a log data matrix LR. The component converts into a numerical value representation and weights the relevant log events E in order to represent system messages SM and event code frequency TF, which is shown in column 5 in Log data in FIG. 3, in an aggregated form EA on the basis of an episode or a time window, for example an hour or a day. These features are finally represented in a log data matrix LR. Finally, this component normalizes each feature value using a predefined normalization value (TF-IDF/Z-Score) based, wherein TF-IDF (term frequency=frequency of occurrence and inverse document frequency) is used to assess the relevance of terms or system terms in a document or a file e.g. log file. The weighting computed in this manner (see second row of LR in FIG. 3) for a term with reference to the log file that contains it allows better arrangement of files as search hits for a term search in the hits list than would be possible using the term frequency alone, for example. A Z-score or value allows a random sample value to be taken from a file or file collection and allows computation of how many standard deviations it is above or below the mean value.

Ep=y*SUM(E_pt),

where E_p relates to the individual occurrence of an event, normalized by y and the aggregation of the respective occurrence of events during a time window (episode) E_pt.

2. A history data integration manager HM for interchanging what are known as history data HD is shown schematically in FIG. 4: this component provides a formal model in collective form, in a replacement matrix ER in the example, historic data—what are known as history data HD—having been collected from each individual appliance part of the system.
a) The average life ALC of an appliance/spare part is ascertained by virtue of details of an average execution time for a specific component with and without any incident since the last replacement. The ALC is determined by a normalization on each component that is involved in the overall system.

ALC=(SUM (Y_ps=op)/SUM(Y_p)),

where Y_p is an individual spare part, Y_ps represents an individual spare part status and op relates to an operating status of the spare part,
b) the ongoing life cycle CLC is ascertained as an ongoing day or hour representation for an individual spare part that has been in operation since its last replacement,

CLC=SUM(Y_ps=op).
c) the expected life cycle ELC is ascertained as a current and normalized representation by virtue of the difference value for ALC and CLC

ELC=y*(ALC−CLC).

To ascertain the expected life cycle, the current or the ongoing life cycle (how long has the component already been running) is related to its average life cycle.

On the basis of the collected historic data, the expected life or life cycle of a component may be related to one or more other components of the appliance or system. This relationship is derivable from the historic data.

3. A learning machine model manager LMM is shown schematically in FIG. 5: this component forms a current, reactive and predictive prediction and/or decision model of the self-diagnosis agent AD. Said model is specified by a formal machine learning model MM that collects features for a machine learning algorithm. It combines the presentation of log data “Log data” from the log data integration manager LIM and of the history data HD from the integration manager HM and links the combined features, in which the rows represent the appliance episodes (for example day, hour) and the columns reproduce the event features. These event features are derived from the system code that occurs within an episode (for example event code, feature value, event group) and from the historic data (history data) HD using ALC, CLC and ELC of each individual appliance part or spare part T of an appliance with a corresponding episode, and ultimately into the log data matrix LR. Each row contains an appliance time for all individual appliances within a system. The components specify the target values for a training on the basis of classifications that are derivable from the historic data. E.g. a specific spare part T has been replaced within a prescribed episode. While the system consists of a long list of different spare parts, this component can group individual spare parts and assign a target value and also group the remaining spare parts and likewise provide them with a target group value. For example, 25 spare parts need to be classified as an individual target and the remaining appliance parts and spare parts need to be classified with a single target value. Using the feature matrix LR and the target values ZW, which are associated with one another, it is possible for the learning algorithm to apply techniques of what is known as bootstrapping in order to arrive at a tree structure that, instantiated as what is known as a regression tree, or is learned using what is known as a random forest RF method. A random forest is a classification method that consists of multiple different, uncorrelated decision trees. All decision trees have grown under a particular kind of randomization during the learning process. For a classification, each tree in this forest can make a decision and the class with the most votes decides the ultimate classification. Besides a classification, the random forest RF can also be used for regression. Optionally, it is possible for a support vector machine SVM to be used.

A support vector machine divides a set of objects into classes such that the broadest possible area remains free of objects around the class boundaries; it is what is known as a large margin classifier. Support vector machines can be used both for classification and for regression.

Decision tree learning using the aforementioned methods uses a decision tree as a predictive model which uses the observations regarding an object for conclusions about a target value for the object, in the example the component. It is used as a predictive modeling approach in statistics, data mining and machine learning. Tree models in which the target variable can assume a finite set of values are called classification trees. In these tree structures, the leaves represent class tags and branches represent relationships with functions that lead to these class tags. Decision trees in which the target values can assume continuous values (typically real numbers) are called regression trees.

The result of the component is a predictive or decision model MM that identifies the appliance part that is most likely affected by the need for maintenance (on the basis of the target value and the trained classifier) in a particular appliance within a particular appliance episode (for example a day).

4. A self-diagnosis agent manager ADM is shown schematically in FIG. 6: this component ADM accepts individual and multiple models MM of a machine learning model manager LMM and records them on a self-diagnosis agent AD. The manager ADM and the agent AD can communicate with one another remotely via a network, the agent AD being able to be implemented at the customer end and the manager ADM being able to be implemented at the service end. Additionally, it records the log data integration manager LIM and the history data integration manager HM in order to rate the model MM. To this end, recording R may be provided for each appliance/system. In order to be able to prescribe a self-diagnosis task for the self-diagnosis agent AD, this component ADM collects event log information from different services or directly from the appliance and converts it into a model representation matrix MR. Predictions for unexpected appliance information are achieved by averaging the predictions of all individual regression trees that are computed by the machine learning model manager LMM. These predictions are also recorded within this component. The result of the component is a decision mark based on the target value ZW and specifies the affected appliance part of the appliance. Additionally, the decision is put into context using decision rules that are derived from the machine learning model MM and applied to the model representation matrix MR.

Although the invention has been illustrated and described in more detail by means of the preferred exemplary embodiment, the invention is not restricted by the examples disclosed and other variations can be derived therefrom by a service engineer without departing from the scope of protection of the invention.

1. A system for diagnosing at least one component requiring maintenance in an appliance and/or installation, having
a) a device, designed for data and/or message interchange with regard to states of one or more components with an analysis unit that is designed to monitor the states of the one or more components and/or events arising thereon and to output them to the device in a systematized form,
b) a device, designed to receive historic data from the one or more components with regard to their life in collective form,
c) a device, designed for data and/or message interchange with a learning machine unit that is designed to deliver a predictive model for identifying at least one component requiring maintenance to the device,
d) an evaluation device that is designed to use the data and/or messages coming from the analysis unit in systematic form, the historic data in collective form and to use the predictive model to identify the one or more components requiring maintenance,
e) a device, designed for data and/or message interchange with a monitoring device that is designed to take the one or more identified components requiring maintenance as a basis for outputting an error message to the monitoring device, which can prompt a visual and/or audible display.

2. The system as claimed in claim 1, wherein the learning machine unit is designed to identify, within a determined time window, one or more components requiring maintenance on the basis of a target value, specified by the respective affected component, for a training on the basis of classifications that are derivable from the historic data of the appliance and/or installation.

3. The system as claimed in claim 1, wherein events and/or states are provided in a systematized form according to their frequency, if need be in a manner provided with a weighting that corresponds to their relevance, within a time window.

4. The system as claimed in claim 1, wherein said collective form reproduces a correlation between the one or more components and other components of the appliance and/or installation.

5. The system as claimed in claim 1, wherein said life represents an expected life cycle, the average life cycle having been related to the ongoing life cycle.

6. The system as claimed in claim 1, wherein the predictive model is representable by a decision tree in which the leaves represent class tags and branches represent relationships to functions and/or rules that lead to these class tags.

7. The system as claimed in claim 1, wherein the evaluation device is integrated in said monitoring device remotely from the system.

8. A method for diagnosing at least one component requiring maintenance in an appliance and/or installation, having the following steps:
a) accepting states from one or more components provided in a systematized form, wherein the states of the one or more components and/or events arising thereon are monitored by an analysis device,
b) receiving historic data from the one or more components with regard to their life in collective form,
c) accepting a predictive model from a learning machine unit that delivers the predictive model for identifying at least one component requiring maintenance,
d) using the states coming from the analysis unit in systematic form, the historic data in collective form and using the predictive model to identify the one or more components requiring maintenance,
e) outputting an error message on the basis of the identification of the one or more components requiring maintenance.

9. The method as claimed in claim 8, wherein one or more components requiring maintenance are identified, within a determined time window, on the basis of a target value, specified by the respective affected component, for a training on the basis of classifications that are derived from the historic data of the appliance and/or installation.

10. The method as claimed in claim 8, wherein events and/or states are provided in a systematized form according to their frequency, if need be in a manner provided with a weighting that corresponds to their relevance, within a time window.

11. The method as claimed in claim 8, wherein said collective form reproduces a correlation between the one or more components and other components of the appliance and/or installation.

12. The method as claimed in claim 8, wherein said life represents an expected life cycle, the average life cycle being related to the ongoing life cycle.

13. The method as claimed in claim 8, wherein the predictive model is represented by a decision tree in which the leaves represent class tags and branches represent relationships to functions and/or rules that lead to these class tags.

14. A computer program having means for performing the method as claimed in claim 8 when the computer program is executed on a system or on the devices of the system as claimed in one of the aforementioned system claims.
